(19) United States
(12) Patent Application Publication
(10) Pub. No.: US 2010/0078843 A1
(43) Pub. Date: Apr. 1, 2010

(54) SYSTEM AND METHOD FOR COATING BIOMEDICAL WIRES WITH INSULATIVE COATING

(76) Inventor: Paul Burros, West Linn, OR (US)

Correspondence Address: ST. JUDE MEDICAL NEUROMODULATION DIVISION, 6901 PRESTON ROAD, PLANO, TX, 75024, US

(21) Appl. No.: 12/566,330

(22) Filed: Sep. 24, 2009

Related U.S. Application Data
(60) Provisional application No. 61/101,382, filed on Sep. 30, 2008.

(51) Int. Cl. B29C 47/92

(52) U.S. Cl. 264/40.7

(57) ABSTRACT

In one embodiment, a method of operating an extruder to coat biomedical wires with insulative material, comprises: feeding a length of biomedical wire through a tip of the extruder; providing extrudate, concurrently with the feeding, through an extruder die of the extruder, wherein the tip is adjustable relative to the extruder die; measuring a back pressure of extrudate behind the tip and extruder die multiple times for multiple locations of the tip relative to the extruder die; selecting a position for the tip relative to the extruder die in relation to a maximum back pressure value determined, in part, by the measuring.

### CROSS-REFERENCE TO RELATED APPLICATIONS

This application claims the benefit of U.S. Provisional Application No. 61/101,382, filed Sep. 20, 2008, which is incorporated herein by reference.

### TECHNICAL FIELD

This application pertains to an apparatus and a method of producing ultra-thin walled extruded polymer products using a polymer extruder.

### BACKGROUND

Polymer extruders are used to produce polymer tubes and ducts and to coat circular, rectangular, stranded and coiled conductors (such as electrical wires, ribbons, cables and coils) with polymer material. As used herein, the term “biomedical wires” is used to refer to any such conductor adapted for implantation within a patient. Coated biomedical wires have a variety of applications within medical devices including electrical stimulation of tissue and biosensing applications.

A common type of extruder employed in manufacturing such extruded polymer products is a “⅜-inch single screw cross-head” extruder 300 shown in FIGS. 13 and 14. In such an extruder, polymers in the form of pellets are placed in a feed hopper 310 and thus fed into an extruder barrel 320. Extruder barrel 320 houses a helical extruder screw 330. It should be noted that commercially available pellets must be repelletized, i.e., resized, to a smaller size for use in ⅜ inch extruders to avoid damage to the extruder screw 330. The polymer fills the spaces between the surface of extruder screw 330 and the interior walls of extruder barrel 320. The screw is rotated about its longitudinal axis by an electric motor 340 while extruder barrel 320 remains stationary. The rotation of extruder screw 330 transports the polymer through extruder barrel 320 creating pressure and friction between the polymer and the interior walls of the extruder barrel 320. The combination of pressure, friction and additional heat provided by heaters melt the polymer. In polymer extrusion, the additional heat is most commonly supplied by electric resistance heaters, which are placed along the exterior of extruder barrel 320.

By the time the polymer has traveled the length of the extruder barrel 320, it is completely melted. The molten polymer, i.e., polymer melt, is then forced through “breaker plate 345,” which is housed in the body of the adapter 346. Breaker plate 345 causes the polymer melt to flow in a linear direction as opposed to a helical direction.

Breaker plate 345 is a metal cylinder which provides five channels, for polymer melt flow, running along the length of the cylinder. For example, the breaker plate that is provided in a typical ⅜-inch extruder is approximately 0.377 inches in length and has an overall diameter of approximately 0.748 inches and provides five channels each having a diameter of approximately 0.110 inches. Accordingly, the overall cross-sectional area of the standard breaker plate is 0.439 square inches and the cross-sectional area provided for polymer flow is approximately 0.047 square inches (the sum of the cross-sectional area of all five channels). Accordingly, the ratio of the total cross-sectional area provided for polymer flow to the overall cross-sectional area of the breaker plate is 0.107.

Breaker plate 345 may also support a filter which is used to remove contaminants from the polymer melt. Typical filters used in polymer extrusion range from 100 to 400 mesh (100-400 lines per square inch).

The polymer melt, after flowing through the breaker plate 345 and filter exits the adapter and enters a crosshead assembly 350 where it is forced through an extruder die 360. The polymer melt emerging from the extruder die 360 is referred to as an extrudate. The shape of the extrudate immediately leaving the extruder die 360 is not the final shape. For example, in wire coating, a wire 318 travels along a wire path through the crosshead assembly where it comes into contact with the polymer melt which coats the wire. Upon emerging from extruder die 360, the walls of the polymer coating rather than being uniformly concentric and parallel forms a cone around the wire. This phenomena is partially attributed to extrudate swell. As the wire is further drawn away from the extruder die 360, the coating walls become uniformly parallel under ideal conditions.

Reference is also made to U.S. Pat. No. 6,814,803 which discloses an extruder having a unitary crossbody head. FIG. 15 depicts a view of crossbody head 400 described in the '803 patent in which a biomedical wire is threaded through a tip-shaped funnel during the coating process of the disclosed extruder. The '803 patent is hereby incorporated herein by reference.

An ultra-thin coating (e.g., less than 50.8 microns in wall thickness) is frequently necessary in biomedical implants, where wires with diameters as small as 25.4 microns (0.001 inch) are used and must substantially retain their inherent flexibility and small diameters. Complete coverage of the wire with polymer is necessary to prevent unintended contact between the bare conductor and body fluids and tissue. When attempts to place ultra-thin coatings on such wires have been made, the resulting coating is often incomplete or covered with “pinholes.”

U.S. Pat. No. 6,814,557 discloses a system in which imaging and/or video equipment is utilized to ensure uniform coating about the medical wires. Although the '557 patent provides a significant improvement over conventional extruders, there are some limitations remaining. For example, opaque extrusion material prevents the imaging functionality of the '557 patent from permitting the operator from discerning whether the extrudate is actually uniformly coating the wire during operation of the extruder. The '557 patent is hereby incorporated herein by reference.

### SUMMARY

In one embodiment, a method of operating an extruder to coat biomedical wires with insulative material, comprises: feeding a length of biomedical wire through a tip of the extruder; providing extrudate, concurrently with the feeding, through an extruder die of the extruder, wherein the tip is adjustable relative to the extruder die; measuring a back pressure of extrudate behind the tip and extruder die multiple times for multiple locations of the tip relative to the extruder die; selecting a position for the tip relative to the extruder die in relation to a maximum back pressure value determined, in part, by the measuring.

The foregoing has outlined rather broadly certain features and/or technical advantages in order that the detailed description that follows may be better understood. Additional features and/or advantages will be described hereinafter which form the subject of the claims. It should be appreciated by those skilled in the art that the conception and specific embodiment disclosed may be readily utilized as a basis for modifying or designing other structures for carrying out the same purposes. It should also be realized by those skilled in the art that such equivalent constructions do not depart from the spirit and scope of the appended claims. The novel features, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the appended claims.

### BRIEF DESCRIPTION OF THE DRAWINGS

FIG. 1 is a partial front view of an extruder.

FIG. 2 is a top view of the extruder of FIG. 1.

FIG. 3 is a side view of the extruder of FIG. 1.

FIG. 4 is a sectional view taken along line 4-4 of the extruder of FIG. 1.

FIG. 5 is a sectional view taken along line 5-5 of the extruder of FIG. 1.

FIG. 6 is a partial sectional view of the extruder of FIG. 1.

FIG. 7 is a partial exploded view of the extruder of FIG. 1.

FIG. 8 is a partial front view and partial schematic view of an extruder system.

FIG. 9 is a partial front view and partial schematic view of an extruder system.

FIG. 10 is a perspective view of a breaker plate that can be used in an extruder system.

FIG. 11 depicts an extruder system communicatively coupled to a control system according to one representative embodiment.

FIG. 12 depicts a flowchart for operating an extruder device according to one representative embodiment.

FIG. 13 is perspective view of a conventional extruder.

FIG. 14 is a front view of a conventional extruder.

FIG. 15 depicts a crossbody head for a known extruder system.

### DETAILED DESCRIPTION

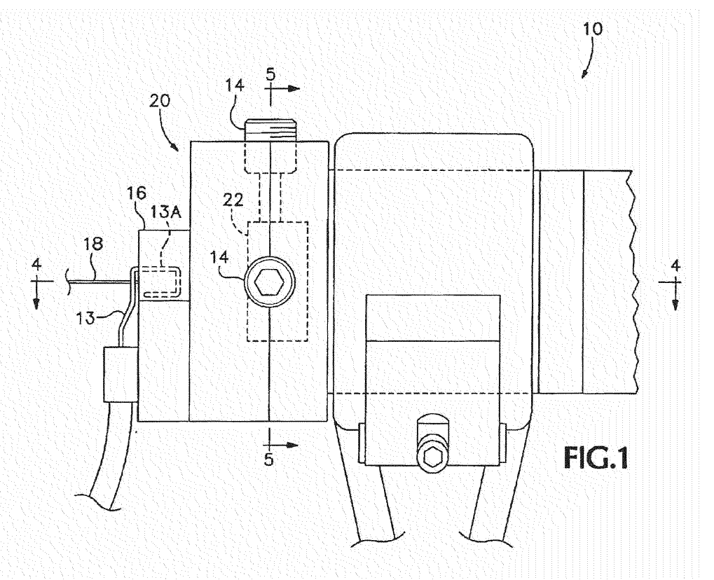

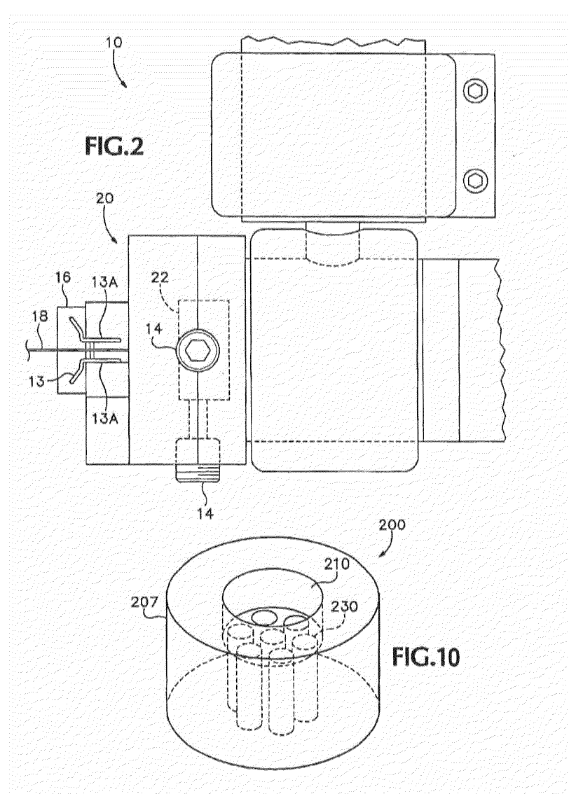

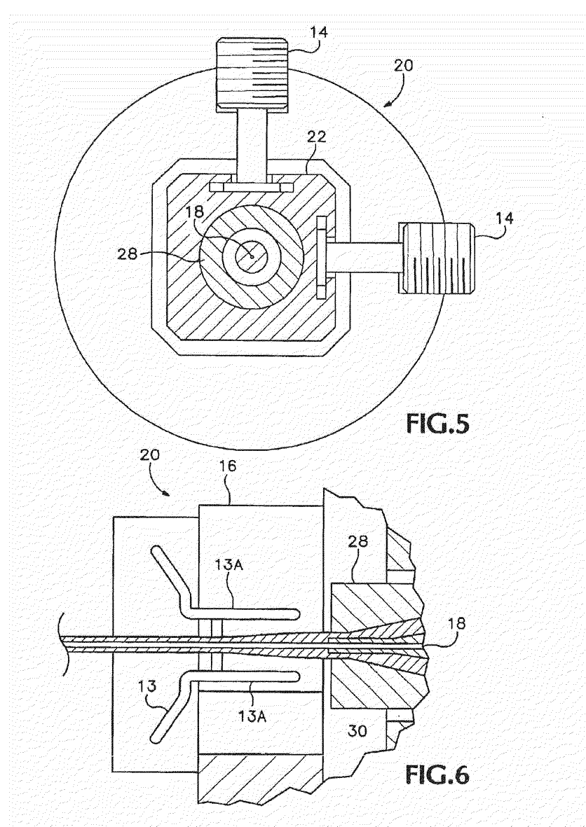

An extruder system for providing thin coatings to biomedical wires is shown as system 10 in FIGS. 1 through 10. FIGS. 1, 2, 3, 4, 6 and 10 depict a cross-head assembly that includes an external extrudate heater 16. Heater 16 may be attached and removed to the exterior of die housing 20 by a securing bolt 24 as an example. Heating the extrudate exiting the extrusion die enables extruder 10 to coat wires 18 as thin as 25.4 microns (0.001 inch) with polymer coats of less than 50.8 microns (0.002 inch) wall thickness. Extrudate heater 16 incorporates a resistance heating element 13 made of a nichrome wire of 16 to 24 gauge (AWG) (35-40 mil) (0.035-0.040 inches). Heating element 13 is bent into a loop 13A to surround the extrudate swell as it exits the die (see FIG. 6).

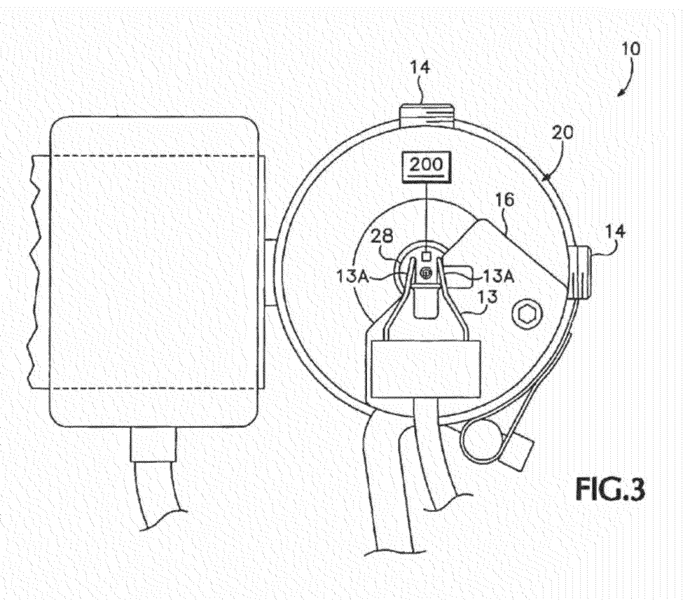

The amount of heat output may be controlled by several methods. In one method, a uniform and steady electric current of approximately 5-20 amps, preferably 10-13 amps, is passed through heating element 13 by an electrical source causing heating element 13 to heat the extrudate emerging from the die. The electric current may be regulated by a feedback controller. Another method of controlling the heating of the extrudate swell is through regulated temperature control. A thermocouple 200 (FIG. 3) is located within the space between the bent heating element 13A and the extrudate swell. The temperature of the extrudate is measured by thermocouple 200 in conjunction with a readily available thermocouple temperature read-out device. The measured temperature may then be controlled with feedback control which manipulates the flow of electric current through heating element 13. The temperature range to be maintained is dependent upon the polymer used. For example, when coating a 25.4 micron diameter conductor with Ethylene Tetrafluoroethylene (ETFE) a temperature range of 730-800° F., preferably 780° F., was found to allow the polymer melt to completely coat the conductor with a polymer coat of less than 50.8 micron wall thickness. A third method of controlling the heat output of heating element 13 is by electrical voltage regulation: the voltage across heating element 13 is set at a specified voltage which controls the flow of electric current.

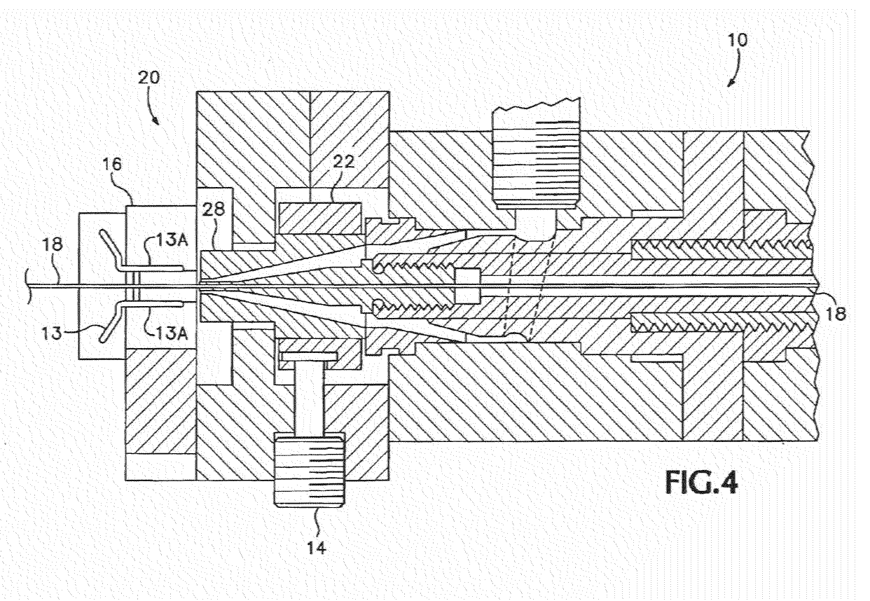

In FIGS. 4, 5, and 7, die 28 is defined by rounded surfaces along its longitudinal axis, and fits snugly into the annular space provided by a die holder 22, thereby allowing die adjustments with adjusting screws 14. The rounded surfaces of die 28 enables die 28 to be manufactured at a lower cost than current dies which are shaped with flat and rounded surfaces along their longitudinal axes. The position of die 28 may be adjusted by manipulating two die holder adjusting screws 14 which in turn pushes and pulls die holder 22 along two different perpendicular lateral directions. The provision of only two die adjusting screws 14 allow for easier and quicker die adjustments. In addition, instead of using adjusting screws 14, the position of die 28 may be adjusted by the incorporation of electrical driver devices such as piezoelectric actuators (not shown).

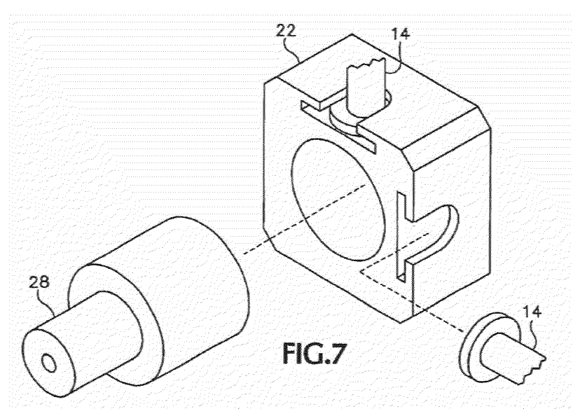

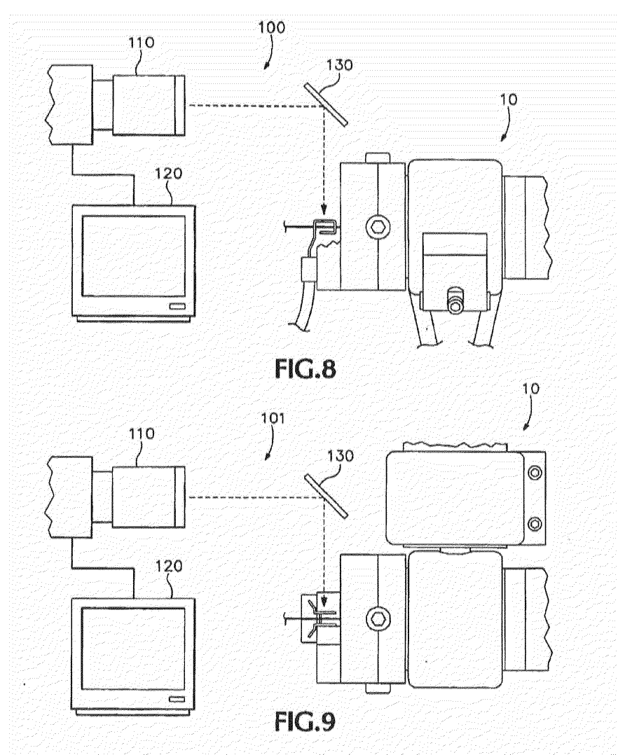

In FIGS. 8 and 9, visual monitoring equipment 100 and 101 (video cameras 110, monitors 120, and mirrors 130) are preferably arranged to provide for up-close visual observation of the extrudate in two different lateral perspectives. Up-close and magnified observation of the extrudate in two perspectives will alert the operator to any non-uniformity or non-concentricity in the extrudate emerging from the extruder die. The use of visual monitoring equipment 100 and 101 is problematic if a substantially or completely opaque extrudate material is employed. Accordingly, other embodiments provide additional or alternative means to facilitate uniform coating of biomedical wires as discussed below.

As shown in FIG. 10, breaker plate 200 preferably comprises a substantially solid cylinder having an outer circumference 207 and an inner circumference 210 which are further defined by a plurality of uniform diameter channels 230. In one embodiment, breaker plate 200 for a ⅜-inch extruder was manufactured to seven channels 230 for extrudate flow, although less or more channels 230 could be employed according to other embodiments.

The increased cross-sectional area provided by breaker plate 200 minimizes polymer melt flow resistance and corresponding die pressure. Also, the increased flow area reduces the residence time of the polymer melt in the extruder barrel. This reduction minimizes the thermal degradation of the polymer, thereby minimizing the formation of polymer melt contaminants such as gels and thermal polymer degradation products. In addition, the increased area also allows for use of finer filters for filtering out polymer melt contaminants. These contaminants promote pin-hole formation in ultra-thin extrusions. Filters larger than 3 microns, e.g., 100-400 mesh, have been found to be insufficient for ultra-thin wall extrusion.

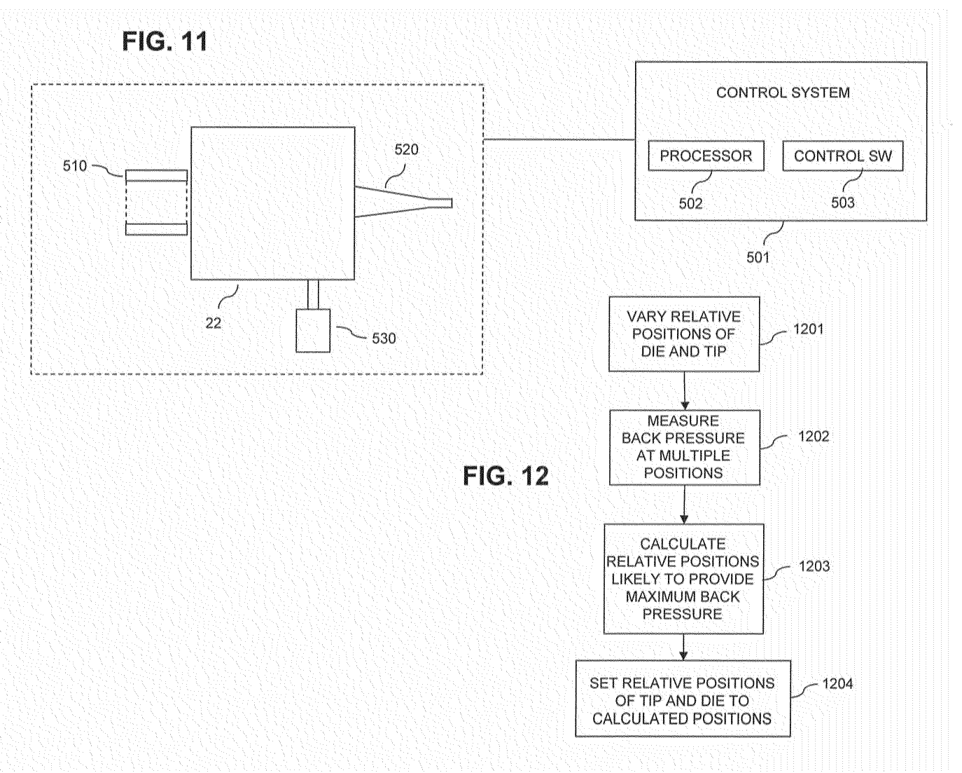

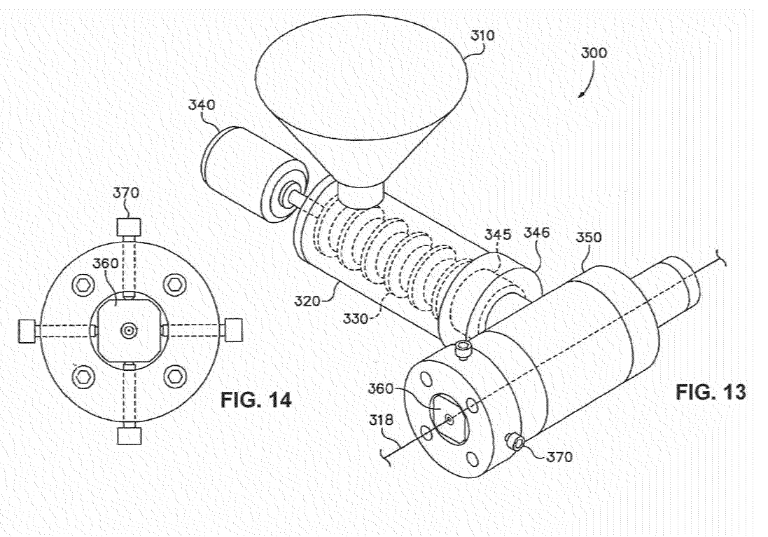

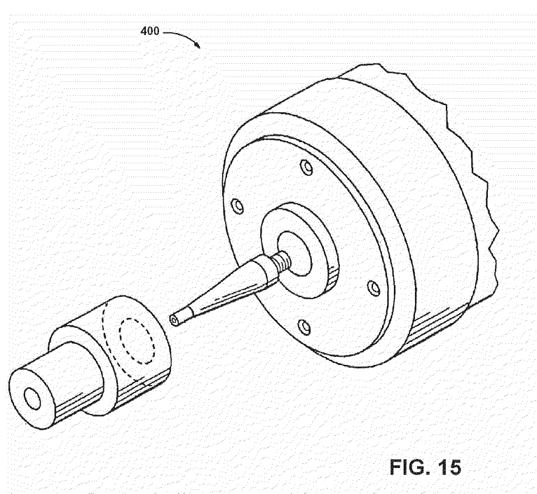

FIG. 11 depicts a portion of an extruder communicatively coupled to control system 501 according to one representative embodiment. As shown in FIG. 11, back pressure sensor 510 is provided within the extruder to measure the pressure on the extrudate. Although sensor 510 is shown in proximity to die 22 and tip 520, sensor 510 can be located elsewhere according to some embodiments. Back pressure sensor 510 may be disposed in any appropriate location within the extruder that permits a reasonably accurate measurement of the back pressure and that does not unduly interfere with flow of the molten polymer material.

Control system 501 includes a processor 502 and control software 503. Through its coupling to the extruder system, control system 501 is able to start and stop the operation of the extruder. Control system 501 is also capable of adjusting the relative positions of die 22 and tip 520 using one or more adjustment mechanisms 530. By adjusting the relative positions, control system 501 is able to control the uniformity of the coating applied to the biomedical wire. In one preferred embodiment, control system 501 automatically controls adjustment mechanisms 530 in response to back pressure measurements, e.g., either during a set-up process or in real time during coating of biomedical wire by the extruder system.

It has been discovered by the inventor that the back pressure measured by sensor 510 is highest when the coating of the wire is substantially uniform. Control system 501 uses this discovery to automatically control the operations of extruder. FIG. 12 depicts a flowchart for operating an extruder system according to one representative embodiment. In 1201, the relative positions of the die and the tip of the extruder are varied. In 1202, back pressure measurements at the varied positions are made. In 1203, the relative positions of the die and tip are calculated which are likely to provide maximum back pressure. In 1204, relative positions of tip and die are set to their respective calculated relative positions.

In one embodiment, control system 510 may position tip 520 in a relatively nominal neutral position relative to die 22. Control system 510 may then vary the relative position of die 22 and tip 520 along a first axis (e.g., the “X” position) while holding the relative position along the other axis constant. Control system 510 may record back pressure measurements at various positions along the first axis. Control system 510 may then generate an interpolation or suitable polynomial fitting of the back pressure measurements along the first axis. From the interpolation or fitting, control system 510 then calculates a position along the first axis that is likely to generate a greatest back pressure measurement along the first axis. This process is then preferably repeated for the other axis. After completing the measurements and calculations for both axes, control system 510 has identified a two-dimensional relative location for die 22 relative to tip 520 which should provide a relative uniform coating during operation of the extruder. In another embodiment, the variation of relative positions, measurement of back pressure, and calculation of an optimal relative position may be performed in an iterative manner using the previously calculated optimal position as a starting point.

Some embodiments provide an efficient and automatic set-up process to permit the operation of an extruder system to provide uniform coating of biomedical wires. In certain other embodiments, the back pressure can be monitored during operation of the extruder to ensure that the uniform coating of the biomedical wire is continuing as expected. Although one particular process of back pressure measurements has been described, the present invention is not so limited. Any suitable sampling of measurements and/or subsequent calculations may occur to identify a location likely to provide a greatest amount of back pressure and, hence, a greatest amount of coating uniformity. Also, although the process is preferably automated, manual performance of the set-up procedure using back pressure measurements may be performed according to alternative embodiments.

Although certain representative embodiments and advantages have been described in detail, it should be understood that various changes, substitutions and alterations can be made herein without departing from the spirit and scope of the appended claims. Moreover, the scope of the present application is not intended to be limited to the particular embodiments of the process, machine, manufacture, composition of matter, means, methods and steps described in the specification. As one of ordinary skill in the art will readily appreciate when reading the present application, other processes, machines, manufacture, compositions of matter, means, methods, or steps, presently existing or later to be developed that perform substantially the same function or achieve substantially the same result as the described embodiments may be utilized. Accordingly, the appended claims are intended to include within their scope such processes, machines, manufacture, compositions of matter, means, methods, or steps.

1. A method of operating an extruder to coat biomedical wires with insulative material, comprising:
feeding a length of biomedical wire through a tip of the extruder;
providing extrudate, concurrently with the feeding, through an extruder die of the extruder, wherein the tip is adjustable relative to the extruder die;
measuring a back pressure of extrudate behind the tip and the extruder die multiple times for multiple locations of the tip relative to the extruder die;
selecting a position for the tip relative to the extruder die in relation to a maximum back pressure value determined, in part, by the measuring.

2. The method of claim 1 wherein the selecting is performed automatically by software code.

3. The method of claim 2 further comprising:
estimating a location, by software code, where the maximum back pressure value is likely to be found using multiple back pressure measurements.

4. The method of claim 1 wherein the selecting is performed manually.

5. The method of claim 1 wherein the extrudate is substantially opaque.

6. The method of claim 1 further comprising:
providing one or more signals to one or more actuators to adjust the location of the tip relative to the extruder die in response to the selecting.

7. The method of claim 6 wherein the providing is performed, in part, by software code.

8. The method of claim 1 further comprising:
continuously monitoring back pressure during operation of the extruder.

9. The method of claim 8 further comprising:
automatically adjusting a relative position of the tip relative to the extruder die in response to the continuously monitoring.
